(19) United States
(12) Patent Application Publication
(10) Pub. No.: US 2010/0233362 A1
(43) Pub. Date: Sep. 16, 2010

(54) Method of Resisting Dust and Dirt with Nanotechnology

(75) Inventor: Chih-Hao Huang, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei (TW)

(21) Appl. No.: 12/786,082

(22) Filed: May 24, 2010

Related U.S. Application Data
(63) Continuation-in-part of application No. 12/114,789, filed on May 4, 2008.

(51) Int. Cl. B05D 5/08

(52) U.S. Cl. 427/126.3

(57) ABSTRACT

A method of resisting dust and dirt with nanotechnology adapted for electronic products is described hereinafter. Firstly, make an initial reactant into a metal oxide gel of nanometer by way of a sol-gel method. Secondly, dilute the metal oxide gel of nanometer with a diluent to form a coating solution, and then stand the coating solution for a period of time to make the metal oxide gel of nanometer and the diluent well mixed with each other. Next, coat the coating solution onto surfaces of the product evenly to fill up tiny holes on the surfaces of the product. Lastly, put the product coated with the coating solution at the temperature of 20˜22° C. to make the coating solution evaporate so as to form continuous protective films on the surfaces of the product for fully filling up the tiny holes.

### CROSS-REFERENCES TO RELATED APPLICATIONS

This is a continuation-in-part application for the application Ser. No. 12/114,789 filed on May 4, 2008, which is incorporated herewith by reference.

### BACKGROUND OF THE INVENTION

1. Field of the Invention

The present invention generally relates to a method of resisting dust and dirt with nanotechnology, and more particularly to a method of resisting dust and dirt with nanotechnology applied to electronic products.

2. The Related Art

With the development of electronic technology, various kinds of electronic products have been used in our daily life and the living extensively. However, with the increase in service time of the electronic product, a great deal of dust and dirt are apt to be adhered to surfaces of the electronic product to result in aesthetic problems thereof. According to a microcosmic viewpoint, the reason why the dust and the dirt being apt to be adhered to the electronic product is mainly that the surfaces of the electronic product have a lot of tiny holes and some dust and dirt particles are smaller than the tiny holes. Therefore, if the electronic product want to well resist dust and dirt so as to keep the aesthetic thereof, the tiny holes on the surfaces of the electronic product must be filled up effectively.

A conventional method of resisting dust and dirt is achieved by means of utilizing silica as an initial reactant to form a coating solution which is coated onto surfaces of a pottery. Then the pottery coated with the coating solution is putted into an oven which is gradually heated up to 150˜200° C. with a heating rate of 0˜2° C./min and then bake the pottery for twenty minutes to one hour. Next, the temperature in the oven is gradually lowered below 70° C. with a cooling rate of 0˜1.7° C./min. Lastly, take out the pottery from the oven with protective films being formed on the surfaces of the pottery. However, if the protective film formed by the above-mentioned method would have the performance of resisting dust and dirt, the process of forming the film generally need high temperature, but the bake process under the high temperature causes that the above-mentioned method is not adapted for the electronic products. When the film is formed under a room temperature, it often shows a porous structure so that cannot effectively resist dust and dirt.

### SUMMARY OF THE INVENTION

An object of the present invention is to provide a method of resisting dust and dirt with nanotechnology, which is adapted for electronic products mainly and can make the electronic products become resistive to dust and dirt well.

The method of resisting dust and dirt with nanotechnology is described hereinafter. Firstly, make an initial reactant into a metal oxide gel of nanometer by way of a sol-gel method. Secondly, dilute the metal oxide gel of nanometer with a diluent to form a coating solution, and then stand the coating solution for a period of time to make the metal oxide gel of nanometer and the diluent well mixed with each other. Next, coat the coating solution onto surfaces of the product evenly to fill up tiny holes on the surfaces of the product. Lastly, put the product coated with the coating solution at the temperature of 20˜22° C. to make the coating solution evaporate so as to form continuous protective films on the surfaces of the product for fully fill up the tiny holes.

As described above, the method of resisting dust and dirt with nanotechnology can effectively fill up the tiny holes on the surfaces of the electronic product and form the continuous protective films thereon at the temperature of 20˜22° C. Therefore, the electronic products processed by the method of resisting dust and dirt with nanotechnology can well resist dust and dirt.

### DETAILED DESCRIPTION OF THE PREFERRED EMBODIMENT

A method of resisting dust and dirt with nanotechnology according to the present invention is mainly applied to electronic products and is described hereinafter.

Firstly, make a proper initial reactant into a metal oxide gel of nanometer by way of a sol-gel method, wherein the initial reactant can be any of all kinds of metal alkane oxides. How to make the metal oxide gel of nanometer is illustrated with an example of making the silicon dioxide gel of nanometer as following.

In a room temperature (20˜22° C.), 99.5% concentration of ethanol, de-ionized water and acetic acid as the catalyst are mixed together to form a mixture solution. Then tetraethoxysilane is added into the mixture solution to react for 12˜24 hours, wherein the weight ratio of the tetraethoxysilane, the ethanol, the de-ionized water and the acetic acid is 10˜20:25:3:0.4˜0.8. In the reaction process, the mixture solution is agitated with a magnetic stirrer. After the reaction process, the mixture solution becomes into a silicon dioxide sol, the silicon dioxide sol is stood for 12˜24 hours to form the silicon dioxide gel of nanometer with a full hydrolyzation and polymerization.

Secondly, dilute the metal oxide gel of nanometer with an alcohol solvent to form a coating solution, wherein the weight percentage of the metal oxide gel of nanometer in the coating solution is 15˜30%. Then stand the coating solution for 24 hours to make the metal oxide gel of nanometer and the alcohol solvent well mixed with each other.

Next, coat the coating solution onto surfaces of the electronic product evenly by way of spraying, soaking or wiping so as to effectively fill up tiny holes on the surfaces of the electronic product.

Lastly, put the electronic product coated with the coating solution at the temperature of 20˜22° C. to make the coating solution dry (namely, evaporate to be a gas phase) naturally so as to form continuous protective films on the surfaces of the electronic product for resisting dust and dirt.

The principle of the above-mentioned method of resisting dust and dirt with nanotechnology is similar to a lotus effect. The lotus effect is that mud and water can only roll on a lotus leaf but can't be adhered to the lotus leaf, because the structure of the lotus leaf is a nanometer structure. According to the lotus effect, the electronic product processed by the method of resisting dust and dirt with nanotechnology can effectively fill up the tiny holes on the surfaces of the electronic product and form the continuous protective films thereon so as to attain an above-mentioned result to make the electronic product become resistive to dust and dirt well.

An unlimited embodiment is described as follows. In the unlimited embodiment, the electronic product is a white mouse and the initial reactant is a silane oxide. The silane oxide is made into a silica gel of nanometer by way of the sol-gel method. Dilute the silica gel of nanometer with an ethanol solvent to form a coating solution and stand the coating solution for 24 hours to make the silica gel of nanometer and the ethanol solvent well mixed with each other, wherein the weight percentage of the silica gel of nanometer in the coating solution is 30%. Coat the coating solution onto a left key of the mouse evenly, and then put the mouse at 20° C. to make the coating solution evaporate naturally so as to form a continuous protective film on the left key. Next, alternately wipe the left key and a right key of the mouse with a cloth covered with a great deal of dust and dirt for 20 times. At last, observe the mouse, the left key coated with the coating solution almost has no dust and dirt, but the right key is stained with a great deal of dust and dirt. Therefore, it is known from the above-mentioned unlimited embodiment that the mouse processed by the method of resisting dust and dirt with nanotechnology can really resist dust and dirt well.

Another unlimited embodiment is described as following. In this unlimited embodiment, a flexible cable is wrapped with a continuous protective film of silicon dioxide of nanometer formed at 20˜22° C. Then bend the cable repeatedly for 500 times. Next, repeatedly wipe the cable with a cloth covered with a great deal of dust and dirt for 20 times. At last, observe the cable. As a result, the cable with the protective film therearound almost has no dust and dirt. Therefore, it is known from the above-mentioned unlimited embodiment that the flexible cable processed by the method of resisting dust and dirt with nanotechnology can really resist dust and dirt well even if the flexible cable is bent over and over again.

As described above, the method of resisting dust and dirt with nanotechnology can effectively fill up the tiny holes on the surfaces of the electronic product and form the continuous protective films thereon at the temperature of 20˜22° C. Therefore, the electronic products processed by the method of resisting dust and dirt with nanotechnology can well resist dust and dirt. Moreover, the method of the present invention can be further applied to flexible products, such as cables, wires and tubes, because the protective film is continuous and can be formed at lower temperature of 20˜22° C. that has no influence on the performance of the flexible products.

What is claimed is:

1. A method of resisting dust and dirt with nanotechnology adapted for electronic products, comprising the steps of:
firstly, making an initial reactant into a metal oxide gel of nanometer by way of a sol-gel method;
secondly, diluting the metal oxide gel of nanometer with a diluent to form a coating solution, and then standing the coating solution for a period of time to make the metal oxide gel of nanometer and the diluent well mixed with each other;
next, coating the coating solution onto surfaces of the product evenly to fill up tiny holes on the surfaces of the product; and
lastly, putting the product coated with the coating solution at the temperature of 20˜22° C. to make the coating solution evaporate so as to form continuous protective films on the surfaces of the product for fully filling up the tiny holes.

2. The method of resisting dust and dirt with nanotechnology as claimed in claim 1, wherein the initial reactant is any of metal alkane oxides.

3. The method of resisting dust and dirt with nanotechnology as claimed in claim 2, wherein the initial reactant is tetraethoxysilane, and silicon dioxide gel of nanometer is formed by the sol-gel method.

4. The method of resisting dust and dirt with nanotechnology as claimed in claim 3, wherein the silicon dioxide gel of nanometer is formed by firstly mixing ethanol, de-ionized water and acetic acid together to form a mixture solution, then the tetraethoxysilane is added into the mixture solution to react for 12˜24 hours, after the reaction process the mixture solution becomes into a silicon dioxide sol, the silicon dioxide sol is stood for 12˜24 hours to form the silicon dioxide gel of nanometer with a full hydrolyzation and polymerization.

5. The method of resisting dust and dirt with nanotechnology as claimed in claim 4, wherein the weight ratio of the tetraethoxysilane, the ethanol, the de-ionized water and the acetic acid is 10˜20:25:3:0.4˜0.8.

6. The method of resisting dust and dirt with nanotechnology as claimed in claim 4, wherein the mixture solution is agitated with a magnetic stirrer in the reaction process.

7. The method of resisting dust and dirt with nanotechnology as claimed in claim 1, wherein the diluent is an alcohol solvent.

8. The method of resisting dust and dirt with nanotechnology as claimed in claim 7, wherein the weight percentage of the metal oxide gel of nanometer in the coating solution is 15˜30%.

9. The method of resisting dust and dirt with nanotechnology as claimed in claim 8, wherein the coating solution is stood for 24 hours.

10. The method of resisting dust and dirt with nanotechnology as claimed in claim 1, wherein the coating solution is coated onto the surfaces of the product by way of spraying, soaking or wiping.

11. The method of resisting dust and dirt with nanotechnology as claimed in claim 1, wherein the method is further adapted to be used to flexible products since the protective film is continuous and formed at lower temperature of 20˜22° C.
